(19) United States
(12) Patent Application Publication
(10) Pub. No.: US 2024/0369055 A1
(43) Pub. Date: Nov. 7, 2024

(54) DEVICE FOR GENERATING A FLUID FLOW

(71) Applicant: FinX, Le Havre (FR)

(72) Inventors: Harold Guillemin, Seine-Port (FR); Vincent Randon, Etouy (FR); Lucas Comiti, Serra-di-Scopamene (FR)

(21) Appl. No.: 18/573,283

(22) PCT Filed: Jun. 28, 2022
(86) PCT No.: PCT/FR2022/051282

§ 371 Date: Dec. 21, 2023

(30) Foreign Application Priority Data
Jun. 28, 2021 (FR) FR2106940

(51) Int. Cl. F04B 43/00; F04B 43/02; H02K 1/34

(52) U.S. Cl. CPC F04B 43/0018; F04B 43/02; H02K 1/34

(57) ABSTRACT

A device for generating a fluid flow extending in a longitudinal direction includes:
a frame,
at least one flange arranged on a transverse face,
at least one transversely extending membrane arranged opposite the at least one flange, the at least one membrane having a flange face opposite the at least one flange, and an outer face opposite the flange face, and
at least one actuator configured to cause the at least one membrane to move in a reciprocating translational motion,
wherein none of the walls are opposite the outer face of the at least one membrane.

### CROSS-REFERENCE TO RELATED APPLICATIONS

This application is a national phase entry under 35 U.S.C. § 371 of International Patent Application PCT/FR2022/051282, filed Jun. 28, 2022, designating the United States of America and published as International Patent Publication WO 2023/275482 A1 on Jan. 5, 2023, which claims the benefit under Article 8 of the Patent Cooperation Treaty of French Patent Application Serial No. FR2106940, filed Jun. 28, 2021.

### TECHNICAL FIELD

The present disclosure relates to a device for generating a fluid flow, preferably hydraulic, for example, a hydraulic thruster, a pump, a fan or a mixer, the device comprising at least one actuator, the mobile part of which performs an alternating linear translational movement.

### BACKGROUND

Devices for generating a fluid flow are known, in particular hydraulic flow-generating devices.

However, it is thus desirable to propose a simple, economical, ecological solution allowing adjustment of the power and/or flow rate, and offering a reduced form factor.

### BRIEF SUMMARY

To this end, and according to a first aspect, the present disclosure proposes a device for generating a fluid flow extending in a longitudinal direction (L), including:
a frame,
at least one flange,
at least one membrane extending transversely and arranged opposite the at least one flange, the at least one membrane having an exterior face oriented toward the outside of the device, and
at least one actuator configured to cause the at least one membrane to move in a reciprocating translational motion,
wherein none of the walls are opposite the outer face of the at least one membrane.

The device for generating a fluid flow according to the present disclosure has the advantages of proposing a small number of parts, a reduced form factor, of avoiding clogging by objects, of the algae type, in a propulsion chamber that would be composed of flanges and of allowing a high-frequency reciprocating movement. This arrangement also makes it possible to propose a device for generating a fluid flow offering a low manufacturing and maintenance cost.

According to alternative embodiments, the device may comprise one or more of the following elements or features:
the at least one flange is arranged on a transverse face, the at least one membrane having a flange face opposite the at least one flange, the exterior face being opposite the flange face;
a single flange and a single membrane;
a single flange and a pair of membranes arranged one behind the other, preferably coaxially, able to operate in phase or in opposition; and/or
at least two flanges and at least two membranes, each flange being arranged at a distinct end of the frame or actuator.

A flange is understood to mean a wall positioned transversely relative to a longitudinal direction corresponding to the flow of the fluid, in particular hydraulic flow. Each flange cooperates with at least one membrane in order to locally pressurize the fluid present in order to locally produce an increase in flow rate relative to the surrounding environment.

Preferably, each flange is arranged at a longitudinal end of the frame or actuator.

Each flange may be rigid or flexible having a certain elasticity. It may have various shapes, for example, rectangular, cylindrical, circular, elliptical, discoidal, or tubular. It may comprise voids, asperities or lips enabling a pressure rise. Each flange is composed of or consists of one or more specific materials, for example, marine, food-safe, biocompatible, or hydrocarbons. For example, the flange comprises one or more of the following materials: PBT, ASA, ABS, PVC, PTFE, PEEK, PA, PET, PE, aluminum, stainless steel, and elastomer.

According to a particular embodiment, a flange may be a nautical vehicle shell element, for example, a hull element of a boat.

Preferably, each membrane may have various shapes, for example, rectangular, cylindrical, circular, elliptical, discoidal, or tubular. Each membrane is composed of or consists of one or more specific materials, for example, marine, food-safe, biocompatible, or hydrocarbons. For example, each membrane comprises one or more of the following materials: elastomer, rubber, polyurethane, EPDM, silicone, PTFE, or even plastics, or metal.

Each membrane is arranged to be moved in translation in a straight and alternating manner along the longitudinal axis of the device. Each membrane is provided to oscillate with a predetermined frequency and amplitude.

According to alternative embodiments, the device may further comprise one or more of the following elements or features:
the at least one flange has a tubular section extending coaxially to the longitudinal axis, this feature making it possible to produce a Venturi effect;
the at least one membrane has a central opening, preferably having a diameter that is greater than the diameter of the tubular section of a flange;
the at least one flange and the at least one membrane respectively have an oval shape, and/or
the at least one flange and the at least one membrane respectively have a circular shape.

Preferably, the at least one actuator is arranged on or in the frame so that the device has a free central zone. This feature in particular allows a fluid to pass longitudinally through the flow-generating device.

Preferably, the flow-generating device does not comprise a wall facing the exterior face of the at least one membrane. In particular, the flow-generating device does not comprise a wall extending transversely and facing the exterior face of the at least one membrane. Preferably, the flow-generating device does not comprise a side wall extending around, in particular radially, the at least one flange and the at least one membrane.

The aforementioned wall or walls make it possible to guide the flow of the flow-generating devices, in particular propeller devices, and can improve flow parameters.

The at least one actuator may be or comprise an electromagnetic machine. The electromagnetic machine comprises a fixed part, called a stator part, and a mobile part.

A stator is understood to mean the fixed part of the electromagnetic machine. It is attached to the frame of the machine. Preferably, the stator consists of a stack of sheet metal plates made of ferromagnetic materials, preferably soft iron, and a winding of a conductive wire. The stator generates the electromagnetic field when an electric current passes through the conducting wire.

According to a first embodiment, the at least one actuator is an electromagnetic machine comprising:
a stator arranged to create a magnetic field, comprising at least two stator elements, arranged around the longitudinal axis and extending in a circumferential or orthoradial direction relative to the longitudinal axis; and
a linearly movable portion, comprising at least two distinct movable rods along respective drive axes, and spaced along a circumference extending around the longitudinal axis, each rod comprising at least one magnetic element, each rod being arranged between two stator elements and magnetically movable relative to the at least two stator elements.

A stator element is understood to mean a part of the stator generating a portion of the electromagnetic field. Preferably, each stator element comprises a central stack of sheet metal plates, which is surrounded by a winding, and two air gap stacks, each air gap stack being arranged at one end of the central stack. Depending on the shape of the machine, each stator element has at least one rectilinear or circular arc portion. Each air gap stack has a distal end that is provided to be arranged opposite a rod. The distal end of an air gap stack has a shape that is arranged to partially surround a rod of the movable portion. Preferably, the distal end has a shape complementary to the shape of the rod. For example, in the case of a rod of cylindrical shape, the distal end of an air gap stack has a concave shape. For the foregoing and for the remainder of the description, each stator element connects two rods, each rod being spaced apart from a distal end by an air gap.

Preferably, each stator element comprises a set of at least two distinct stacks of sheet metal plates spaced apart longitudinally so as to produce two distinct magnetic circuit portions.

For example, the plates can be powered by one or more coils.

The linearly movable portion comprises at least two magnetic rods. Each rod comprises at least one magnetic element or consists of a magnetic element. Alternatively to the rods, the movable portion of the machine may comprise any mobile part that can bear or consist of at least one magnetic element. The at least one magnetic element is integrated into the outer envelope of the rod or of the part, or it has an external general shape identical to the rod or to the part.

Preferably, each rod comprises at least two pairs of alternating poles. According to an alternative embodiment, each rod comprises at least four pairs of alternating poles. Preferably, each rod comprises a plurality of opposite magnetic poles.

A pair of poles is understood to mean a system having a north pole and a south pole. A pair of poles is preferably a magnet. For example, each rod comprises or corresponds to at least one permanent magnet. Two pairs of alternating poles are understood to mean two systems as defined above arranged in inverted fashion, or so that each pole of a first pair is arranged opposite a pole of reverse polarity of the second pair, or adjacent pair.

According to an embodiment wherein each rod comprises at least one permanent magnet, the latter occupies at least 50%, preferably at least 75% of the cross-section of the rod. Furthermore, each permanent magnet may have a shape substantially identical to the shape of the rod. In the case where the movable rod comprises several magnets, these are aligned coaxially along the drive axis of the rod.

Preferably, each rod comprises a spacer arranged between two pairs of poles. In the case where the mobile rod comprises a plurality of magnets, each rod comprises a spacer arranged between two magnets. This feature makes it possible to define a force or amplitude of motion of the rod bearing the spacer. The spacers can be magnetizable or non-magnetic, depending on the desired force and amplitude.

According to another embodiment, each rod consists of a ferromagnetic material and a non-magnetic material. The permanent magnet(s) are removed from the movable portion of the machine. Thus, one magnet in two can be replaced by a magnetic core, the other is non-magnetic. The coil of the electromagnet of a stator element is mounted so as to operate in positive current only and is short-circuited in the reverse case. This allows each rod in oscillatory fashion to be alternately attracted by the electromagnetic field of the stator, then pushed back, for example, by the force of position return means, preferably a spring. Return means are described below. This embodiment makes it possible to propose a particularly simplified and inexpensive machine.

According to any type of rod, the at least two rods of the movable portion can be spaced along a circle whose longitudinal axis is the center. Preferably, the at least two rods can be spaced equidistant along a circle whose longitudinal axis is the center.

Preferably, the rods are parallel to one another and relative to the longitudinal axis.

The rods may have different shapes. According to a cross-section, each rod may have a parallelepiped, rectangular, hexagonal, cylindrical or circular shape.

Preferably, the volume defined by the at least two stator elements and the at least two rods is free at the center. No part is within the central portion of the machine. This allows various advantages such as, for example:
allowing the passage of a part or a fluid (in particular heat transfer fluid) through the center,
lower volume and weight, which is important for on-board systems,
allowing better gripping of the machine during the handling thereof, or
improving the thermal performance of the machine via better cooling.

According to a second embodiment, the at least one actuator is an electromagnetic machine comprising:
a stator arranged to create a magnetic field, comprising at least two stator elements facing one another,
a linearly movable portion, comprising:
at least two separate rods that are movable along respective drive axes, each rod being arranged at one end of the two stator elements,
at least one magnetic element associated with the at least two rods, the at least one magnetic element being arranged between the two stator elements and being magnetically movable with respect to the at least two stator elements, and
coupling means between the at least one magnetic element and the rods.

A stator element is understood to mean a part of the stator generating an electromagnetic field. Preferably, each stator element comprises a stack of sheet metal plates comprising at least two teeth. Preferably, each stator element comprises a stack of sheet metal plates comprising at least one notch. For example, the sheet metal plates can be powered by one or more coils. The stator elements are arranged in pairs or couples in order to produce one or more magnetic circuits. They are spaced apart from each other so as to insert at least one magnetic element between the teeth and able to move magnetically under the effect of the magnetic field passing through the teeth.

According to one embodiment, each stator element comprises a stack of sheet metal plates comprising three teeth, so as to produce an “E”-shaped pattern. The two notches are occupied by a winding of electrical wires. According to other embodiments, the stator elements may comprise an unlimited number of longitudinally aligned teeth.

The linearly movable portion comprises at least two magnetic rods, the rods being arranged on either side of the pair of stator elements. The rods may have a rectangular cross-section, preferably square, or cylindrical, preferably circular.

The movable portion further comprises at least one magnetic element intended to be moved under the effect of the magnetic field of the stator. The at least one magnetic element is connected to the two rods. Preferably, the at least one magnetic element is arranged between the two rods.

The at least one magnetic element does not fit completely into the rods. According to one embodiment, each magnetic element extends radially or perpendicularly relative to the two rods. According to a preferred embodiment, the movable portion comprises at least one magnetic element connected to two rods.

According to one embodiment of the coupling means, the means comprise:
a rod part arranged to be attached to a rod, and
a magnetic element part arranged to secure the at least one magnetic element, and thus mechanically couple the at least one magnetic element to a rod.

Preferably, the rod part surrounds the outer envelope of a rod and is connected thereto by means for holding in position in order to drive the rod during the movement of the at least one magnetic element. Preferably, the magnetic element part comprises a cavity or recess in order to receive one end or a portion of the at least one magnetic element, such as a key-type mounting in a groove.

According to another embodiment of the coupling means, the means comprise a cavity or recess arranged on the circumference or on an exterior face of a rod, such as a key-type mounting in a groove.

Each magnetic element comprises at least one pair of alternating poles. Preferably, each magnetic element comprises at least two pairs of alternating poles. According to an alternative embodiment, each magnetic element comprises at least four pairs of alternating poles. Preferably, each magnetic element comprises a plurality of opposite magnetic poles.

A pair of poles is understood to mean a system having a north pole and a south pole. A pair of poles is preferably a magnet. Two pairs of alternating poles are understood to mean two systems as defined above arranged in inverted fashion, or so that each pole of a first pair is arranged opposite a pole of reverse polarity of the second pair, or adjacent pair.

According to one embodiment, the at least one magnetic element comprises or is at least one permanent magnet. The magnet(s) may have different geometric shapes. Preferably, each magnet has a generally rectangular shape. Preferably, each magnet has a rectangular cross-section. This embodiment has the advantage of providing a small thickness with respect to the length and/or width in order to maximize the active magnetization area. According to a first variant, each magnet is rectilinear. According to a second variant, each magnet is curved or concave.

Preferably, the linearly movable portion comprises a spacer arranged between two pairs of poles. In the case where the movable portion comprises a plurality of magnets, a spacer is arranged between two magnets. This feature makes it possible to define a force and/or amplitude of motion of the rods connected to the magnets. The spacers can be magnetizable or non-magnetic, depending on the desired force and amplitude.

According to another embodiment, the at least one magnetic element is made of a ferromagnetic material. The permanent magnet(s) are removed from the movable portion of the machine. The machine may further comprise at least one means for returning to position so as to return the at least one magnetic element to the initial position.

According to a particular embodiment, the stator comprises at least four stator elements forming two pairs of two stator elements arranged around a longitudinal axis and extending in a circumferential or orthoradial direction relative to the longitudinal axis, and wherein the linearly movable portion comprises four rods forming two pairs of two rods. For the foregoing and for the rest of the description, a pair of stator elements associated with a pair of rods and at least one magnetic element is also called a module. The electromagnetic machine can thus comprise one or more modules.

Preferably, the at least two pairs of stator elements are spaced along a circle whose longitudinal axis is the center.

According to any type of rod, the at least two pairs of rods of the movable portion can be spaced along a circle whose longitudinal axis is the center. Preferably, the at least two rods can be spaced equidistant along a circle whose longitudinal axis is the center.

Preferably, the rods are parallel to one another and relative to the longitudinal axis.

According to any embodiment, the rods can have different shapes. According to a cross-section, each rod may have a parallelepiped, rectangular, hexagonal, cylindrical or circular shape.

Preferably, the stator elements are arranged so as to define a free central zone. The volume defined by the at least two stator elements and the at least two rods is free at the center. No part is within the central portion of the machine. This allows various advantages such as, for example:
allowing the passage of a part or a fluid (in particular heat transfer fluid) through the center,
lower volume and weight, which is important for on-board systems,
allowing better gripping of the machine during the handling thereof, or
improving the thermal performance of the machine via better cooling.

According to a particular embodiment, the stator comprises twelve stator elements forming six pairs of stator elements, and the movable portion comprises twelve rods, forming six pairs of rods. Preferably, the linearly movable portion comprises two permanent magnets cooperating with each pair of stator elements.

Preferably, the pairs of stator elements and the associated movable portion are arranged in phase opposition in an alternating manner. Three pairs of stator elements are shifted by 180 degrees relative to the other three pairs of stator elements. Preferably, the rods move at a frequency of between 10 and 150 Hz (hertz).

According to any type of electromagnetic machine, the device may comprise the following features.

Preferably, the electromagnetic machine comprises means for guiding in translation, for example, bearings, slides and/or pads. The guiding means can cooperate with the rods, the at least one magnetic element, preferably the magnet(s), and/or the coupling means.

Preferably, the electromagnetic machine comprises means for sealing the stator and/or at least two rods relative to the external environment.

The sealing means comprise rod sealing means. Preferably, two rod sealing means are associated with each rod, each means being arranged at one end of the rod. They make it possible to protect the air gap around each rod. According to one embodiment, a single rod-sealing means is provided, for example, a bellows.

The sealing means must protect the machine from the saline atmosphere, the polluted atmosphere, or fresh or saline water during submersion. For example, the sealing means may be O-rings, sliding elements ensuring sealing, flexible bellows (made of elastomer or metal), or mechanical or a combination thereof. The seals may be the following: wiper seal, buffer seal, single-effect seal double-acting seal, lip seal(s) (or spi seal), spring seal. It is possible to use these seals alone or to combine them in order to obtain different functions, for example, filtering the impurities, performing a pre-sealing in order to obtain a submerged chamber and therefore lubrication of the guide linings and then another seal allowing the complete sealing.

Additionally, the machine, in particular the stator or each coiled stator element, can be made, for example, with an epoxy or silicone resin. Even more additionally, the at least two rods of the movable portion can be surrounded by an oil bath, offering the advantage of maintaining the pressure in the event of deep immersion, or of lubricating and cooling the system permanently.

Furthermore, the electromagnetic machine may comprise at least one position return means associated with at least one rod. According to one embodiment, the machine comprises a position return means for each rod. Preferably, a position return means is a resilient elastic return means, for example, a spring, preferably a metal spring, in particular made of steel. Although each rod produces a reciprocating movement, it may be beneficial to promote the kinetics of one of the two movements. In normal operation, an electromagnetic machine according to the present disclosure, having movable rods oscillating on a polar pitch or being driven to move by control electronics, does not require a return means for the movable rods. However, it may be beneficial to add to it in order to optimize the efficiency of the machine. For example, a spring could be placed at a first end of a movable rod and/or at a second end, opposite the first end, of the movable rod. This feature makes it possible to absorb the kinetic energy during a first phase of the reversal of the movement in order to store potential energy therein and then retransmit it to the mobile rod during the second phase of reversal. These return means also make it possible to avoid any uncontrolled movement of excessive amplitude, which can lead to premature wear of the machine, or to one or more movable rods unintentionally extending out from the machine. Preferably, the oscillation frequency of the rod is the same as the resonance frequency of the system, in order to consume the least possible energy to be set in motion.

The electromagnetic machine comprises power electronics and/or control means so that the movement of the rods of the movable portion is controlled in an open loop by the power electronics. Control is done by means of power electronics making it possible to undulate a voltage at different frequencies such as, for example, an inverter that can vary the effective voltage and frequency.

According to another embodiment, the machine comprises at least one sensor, such as, for example, a sensor for moving the movable portion, or a current sensor. The power electronics and/or the control means control the movement of the rods of the movable portion in a closed loop by virtue of the information from the at least one sensor.

Preferably, the machine comprises a temperature sensor so as to measure the temperature of the machine, connected directly preferably to the control electronics. It can also be protected against excessive warming thanks to a thermal fuse. These two components are preferably mounted at the periphery of the coil and advantageously at its center, since the coil is the main component diffusing the heat.

The control means make it possible to control each module independently, or in a synchronized or non-synchronized manner with other modules, and/or so as to eliminate the imbalances, for example, by controlling the oscillation of two modules in phase opposition.

According to other embodiments, the device may comprise a plurality of actuators. The at least one actuator may be of any type: electrical (linear, or rotary with parts converting the movement), thermal, compressed air, mechanical (manual, such as pedals).

Preferably, the device for generating a fluid flow is a hydraulic flow-generating device. For example, the device can be a pump, a mixer, a thruster, in particular a hydraulic thruster for a nautical vehicle.

According to a second aspect of the present disclosure, a hydraulic thruster is provided for the propulsion of nautical vehicle comprising a flow-generating device according to one or more of the features of the first aspect. The device operates in motor mode. The device comprises control means, or a controller, arranged to control the device in motor mode.

According to a third aspect of the present disclosure, a hydrogenerator is provided comprising a flow-generating device according to one or more of the features of the first aspect. The device operates in generator mode. The device comprises control means, or a controller, arranged to control the device in generator mode.

### BRIEF DESCRIPTION OF THE DRAWINGS

The present disclosure will be better understood on reading the following description, in reference to non-limiting embodiments illustrated by the appended drawings, in which:

FIG. 1 is a perspective view of a hydraulic thruster according to a first embodiment;

FIG. 2 is a longitudinal sectional view of a hydraulic thruster according to the first embodiment, the thruster comprising an electromagnetic machine according to the preceding figure, and a single flange having a central opening and a single discoidal membrane having a central opening;

FIG. 3 is a perspective view of a hydraulic thruster according to a second embodiment, the thruster comprising a single solid flange and comprising a tail with a conical shape and a single membrane having an opening;

FIG. 4 is a longitudinal sectional view of a hydraulic thruster according to the second embodiment, according to the preceding figures;

FIG. 5 is a cross-sectional view of a hydraulic thruster according to FIGS. 3 and 4 and an electromagnetic machine according to one embodiment, the machine comprising four pairs of stator elements and four pairs of rods;

FIG. 6 is a profile view of an electromagnetic machine according to one embodiment comprising upstream rods and downstream rods;

FIG. 7 is a profile view of an electromagnetic machine according to one embodiment comprising rods that are both upstream and downstream;

FIG. 8 is a profile view of a nautical propulsion assembly comprising a hydraulic thruster according to FIG. 1;

FIG. 9 is a perspective view of an electromagnetic machine with cyclic linear movement according to an embodiment of the present disclosure wherein each rod of the movable portion comprises two permanent magnets, the machine being seen without its frame;

FIG. 10 is a perspective view of a mechanical assembly according to one embodiment, the assembly comprising a machine according to the preceding figure and two discoidal membranes, each membrane being arranged at one end of the machine;

FIG. 11 is a perspective view in longitudinal section of a mechanical assembly comprising an electromagnetic machine according to a second embodiment wherein each rod of the movable portion comprises four permanent magnets;

FIG. 12 is a view in accordance with the preceding figure, each rod further comprising two non-magnetic spacers, a spacer between two adjacent permanent magnets;

FIG. 13 is a zoom of the machine of the preceding figure, a rod of the movable portion, carrying four permanent magnets, being seen in an enlarged manner;

FIG. 14 is a perspective view of an electromagnetic machine with cyclic linear movement according to a fourth embodiment of the present disclosure, wherein the machine comprises six pairs of stator elements and six pairs of rods arranged relative to each other so as to form a circle, the frame being shown;

FIG. 15 is a perspective view of an electromagnetic machine with cyclic linear movement according to a first embodiment of the present disclosure, wherein the machine comprises a pair of stator elements and a pair of rods, the frame not being shown;

FIG. 16 is a profile view of two stator elements facing each other, each comprising a winding of electrical wires, the elements being in accordance with the preceding figure;

FIG. 17 is a perspective view of a linearly movable portion according to one embodiment, comprising two permanent magnets arranged between two rods;

FIG. 18 is a front view of a hydraulic thruster according to a third embodiment, the thruster comprising an electromagnetic machine according to another embodiment, and a single flange having a central opening and a single discoidal membrane having a central opening; and

FIG. 19 is a side view of a thruster according to the preceding figure.

### DETAILED DESCRIPTION

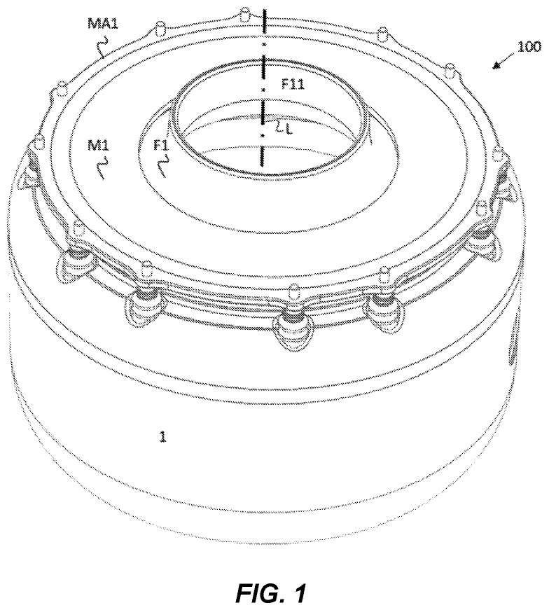

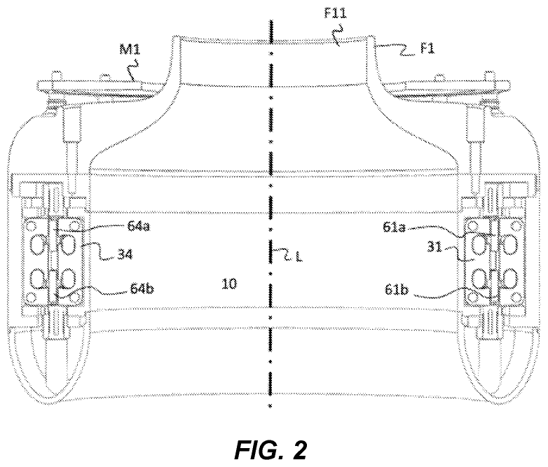

Referring to FIGS. 1 and 2, a first embodiment of a device for generating a fluid flow is presented. The device is in particular arranged to be submerged. The device for generating a fluid flow is a hydraulic thruster 100.

FIG. 2 is a sectional view of a hydraulic thruster comprising an electric actuator, in particular an electromagnetic machine that will be described below, a flange F1 and a membrane M1, the flange and the membrane being arranged on the same end, called the downstream end, of the machine coaxially with respect to the longitudinal axis L. The opposite end, called the upstream end, has no wall preventing the circulation of a flow through the central zone 10 of the electromagnetic machine. In this embodiment, the thruster has the general shape of a tube.

The flange F1 has a central opening so that a flow can pass through it. The flange F1 has a first face, referred to as the connection face, arranged to be connected to an end of an electromagnetic machine, and a second face, referred to as the external face, opposite the connection face. The flange F1 has an inner surface in the form of a cone or nozzle, the largest diameter of the inner surface corresponding to the inner diameter of the electromagnetic machine. The flange further comprises a tubular portion F11 protruding from the external face.

The membrane M1 has the shape of a ring and comprises an armature MA1 connected to all the distal ends of the rods of the electromagnetic machine, see FIG. 1. The membrane M1 has a central opening through which the tubular portion F11 of the flange F1 extends. The membrane M1 has a flange face oriented toward the flange and an exterior face opposite the flange face oriented toward the exterior environment. The device, in particular the hydraulic thruster, is provided to operate without an element, part or appendage that is connected to or remotely adds to the rear face of the device or to the propulsion unit.

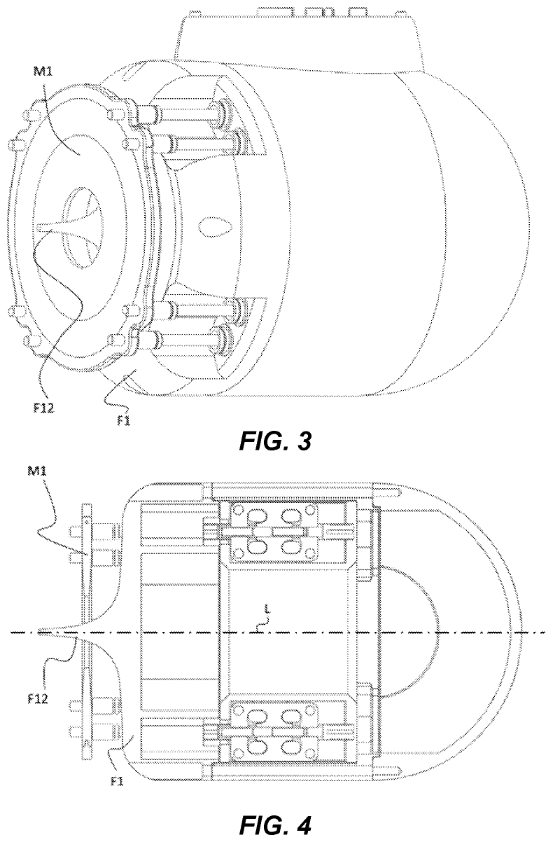

Referring to FIGS. 3 and 4, a second embodiment of a hydraulic thruster is shown. Compared to the preceding embodiment, the present thruster is closed at each end. At least one wall closes the central zone of the electromagnetic machine, so that the thruster has an oblong and/or ovoid general shape.

The flange F1 does not have a central opening. The flange F1 has a first face, referred to as the connection face, arranged to be connected to an end of an electromagnetic machine, and a second face, referred to as the external face, opposite the connection face. The flange further comprises a conical portion F12 protruding from the external face, the diameter of the cone reducing from the external face to the tip of the conical portion. The conical portion passes through the central opening of the membrane M1, see FIGS. 3 and 4.

The association of a flange F1 and a membrane M1 allows the propulsion of the hydraulic thruster.

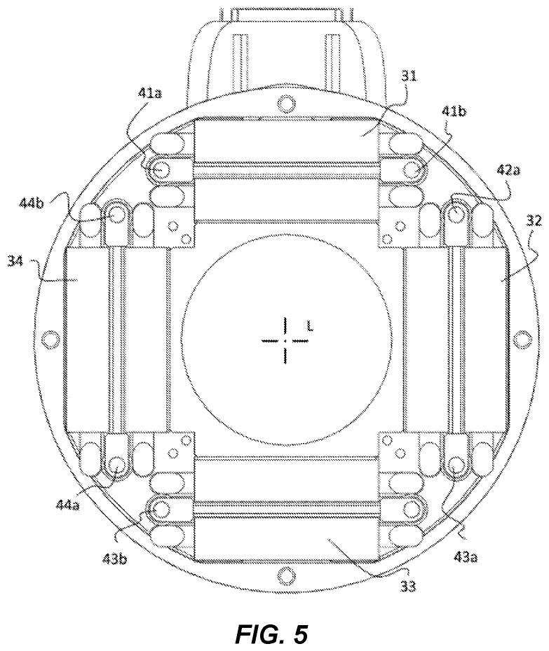

FIGS. 4 and 5 show one embodiment of an actuator. The actuator is an electromagnetic machine. With reference to FIG. 5, an electromagnetic machine comprises a stator and a movable portion comprising magnetic rods magnetically cooperating with the stator. The stator comprises four pairs of stator elements 31, 32, 33 and 34, the pair of stator elements 31 being associated with the pairs of rods 41a, 41b, the pair of stator elements 32 being associated with the pairs of rods 42a, 42b, the pair 33 of stator elements being associated with the pairs of rods 43a, 43b, the pair 34 of stator elements being associated with the pairs of rods 44a, 44b. The electromagnetic machine extends along a longitudinal axis L. The respective drive axes of the rods are parallel to the longitudinal axis L of the machine. Furthermore, the four modules are arranged along a circle whose longitudinal axis L is the center. The four electromagnetic modules are spaced equidistant. Each electromagnetic module can be controlled independently of the others. The electromagnetic machine will be described in more detail below.

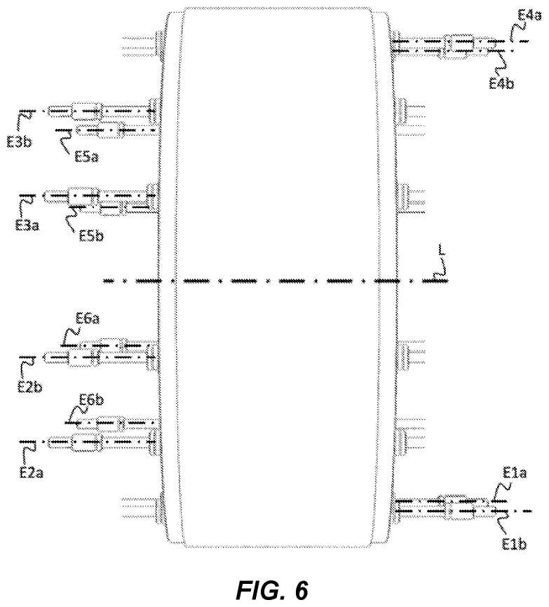

FIG. 6 shows an embodiment of an electromagnetic machine, in particular combinable with one of the embodiments or embodiments that will be described below. The electromagnetic machine comprises pairs of upstream rods extending from a first end of the machine. The machine further comprises pairs of downstream rods extending from a second end, opposite the first end, of the electromagnetic machine. FIG. 6 shows upstream rods extending along the axes E3a, E3b, E5a, E5b, E2a, E2b, E6a, E6b. It is also shown upstream rods extending along the axes E1a, E1b, E4a, E4b. This embodiment makes it possible to place a membrane of each longitudinal end of a device.

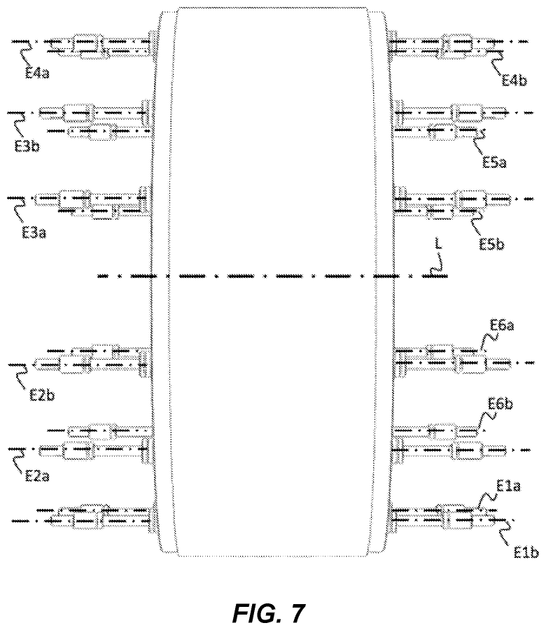

Alternatively, FIG. 7 shows another embodiment of an electromagnetic machine, wherein each pair of rods passes through the frame of the machine in such a way as to pair upstream rods and a pair of downstream rods.

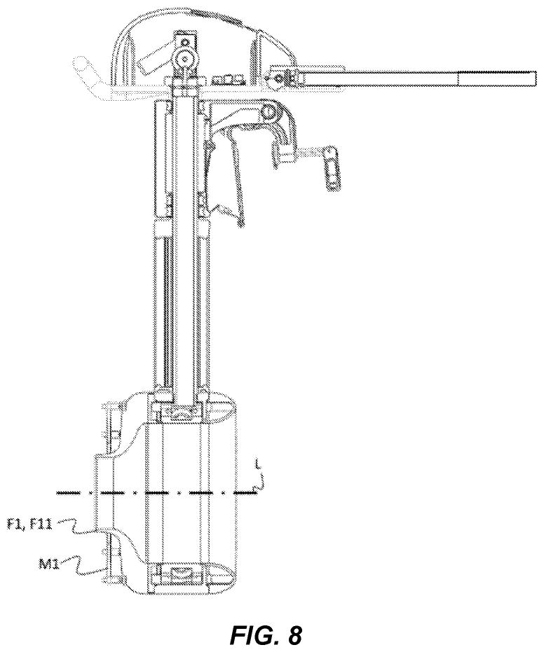

FIG. 8 shows an application wherein the hydraulic thruster according to the first embodiment is connected to a steering and control device of a boat.

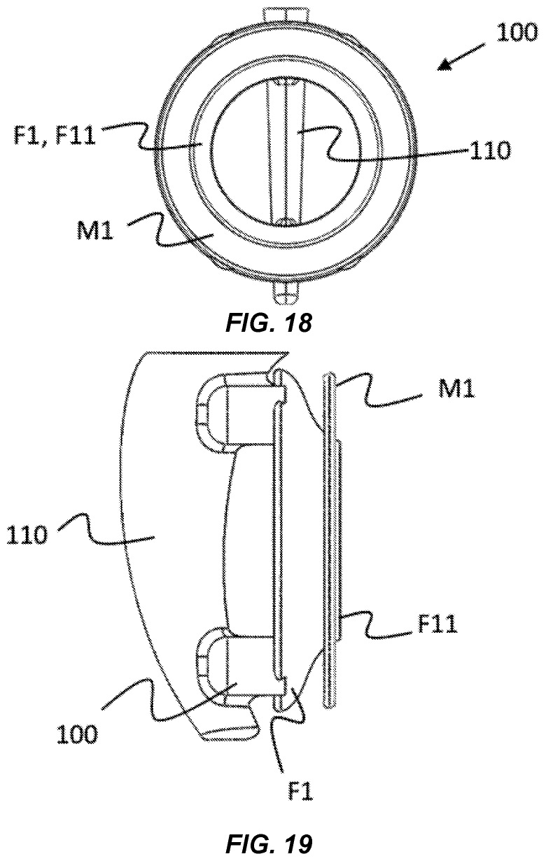

FIGS. 18 and 19 show another application wherein the hydraulic thruster in a minimalist version is connected to a central base of a boat.

The thruster comprises control means and/or power electronics so that the motor is capable of being used in a wide range of use cases. For example, it can be powered by the grid, a solar panel array, or any other AC or DC energy installation or in an energy storage system with its connection through power electronics making it possible to regulate and control the electric current.

Depending on the type of control signal and its shape, the motor can fulfill different use cases: in a case of power supply by a continuous electrical voltage, the position of the motor is controlled. It will therefore maintain a precise and repeatable position according to the supplied electrical voltage value. In the case where an alternating voltage is provided, the speed of the motor will be controlled. The value of the electrical voltage makes it possible to adjust the amplitude of the stroke of the movable bars. As for the frequency of the electrical signal, it is possible to adjust the operating frequency of the motor.

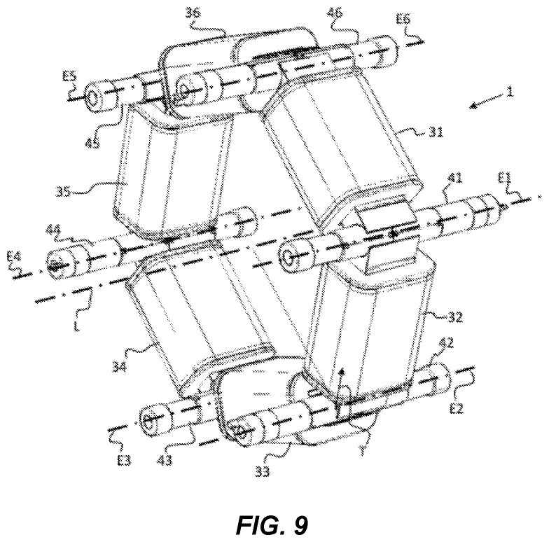

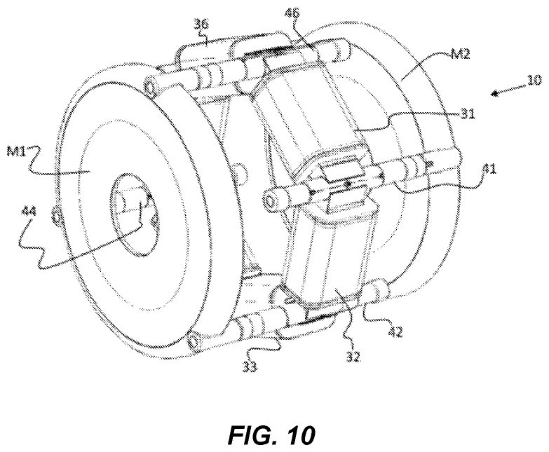

FIGS. 9 to 13 show a first type of embodiment of an actuator, in particular an electromagnetic machine 1 with cyclic linear movement extending along a longitudinal axis L. In order to view as many parts as possible, the machine frame is not shown in FIGS. 9 and 10.

The machine comprises a static part 31, called a stator, arranged to create an electromagnetic field. The stator comprises six stator elements 31, 32, 33, 34, 35 and 36. Each stator element comprises a stack of sheet metal plates surrounded by an electric winding. The six stator elements 31, 32, 33, 34, 35, 36 are arranged around the longitudinal axis L and extend in a circumferential direction T relative to the longitudinal axis L so that the field lines are circumferential by passing through all the stator elements.

The machine comprises a linearly movable portion 4. It comprises six distinct rods 41, 42, 43, 44, 45, 46 along respective drive axes E1, E2, E3, E4, E5, E6. The rods are spaced equidistant along a circumference extending around the longitudinal axis L. This arrangement makes it possible to leave the central zone 10 free. The central zone has a tubular shape.

Each rod has a circular cross section such that each rod has the shape of a bar. For the rest of the description, the word rod or bar may be used interchangeably. Each rod is arranged between two stator elements. Only an air gap separates each rod from the two stator elements. Each rod comprises two permanent magnets aligned along the drive axis of the rod and arranged in inverted fashion from the point of view of the polarities. Each magnet occupies substantially the entire cross-section of the rod and has a circular cross-section. The rods are magnetically movable relative to the stator elements.

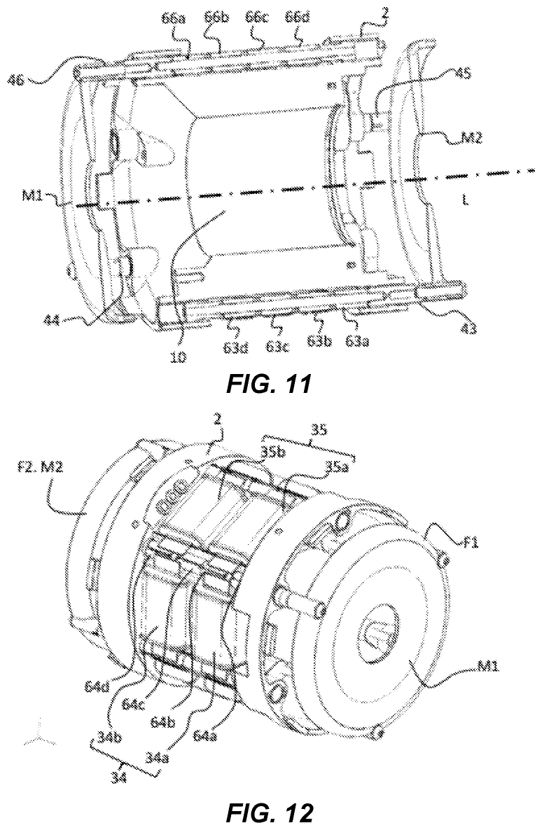

According to an alternative embodiment shown in FIG. 11, each rod of the moveable portion comprises four permanent magnets, only the rods 43 and 46 are visible. In particular, the rod 43 comprises the permanent magnets 63a, 63b, 63c, 63d, and the rod 46 comprises the permanent magnets 66a, 66b, 66c, 66d. Each permanent magnet is in the form of a tube arranged to fit on a cylindrical core of each rod.

This arrangement allows the bars to be driven by the stator following the current magnetic field produced by the latter. The alignment of the poles relative to the stator allows the bars to operate in phase or in phase opposition relative to one another. The alignment of the bars is held by virtue of the magnetic forces of the magnets. The presence of guide means or additional support parts is not indispensable, in the context of a minimalist and/or less expensive embodiment.

Optionally, two guide pieces, preferably cylindrical, serving as a translational guide for each bar, will be attached to the ends of each bar. These guide parts are advantageously made of non-magnetic materials in order to minimize magnetic field leakage. These two parts have the other function of serving as a connecting part for any effector or movable portion that needs to be set into motion.

The presence of a plurality of rods makes it possible to deliver a greater force to an effector. Furthermore, the presence of four permanent magnets instead of two permanent magnets also makes it possible to deliver a greater force to an effector.

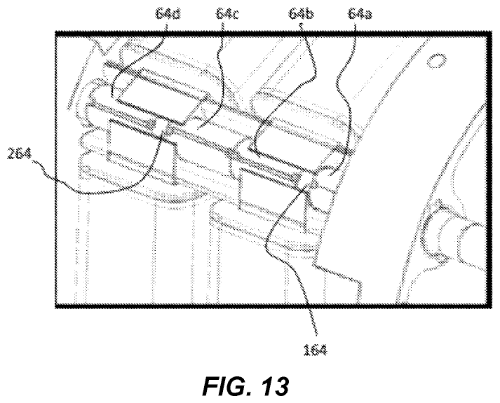

Referring to FIGS. 12 and 13, a particular embodiment of the stator is presented wherein each stator element comprises two stator elements so as to produce two parallel magnetic circuits. Referring to FIG. 12, the stator element 35 comprises two stator sub-elements 35a, 35b and the stator element 34 comprises two stator sub-elements 34a, 34b. Furthermore, the associated rod comprises four permanent magnets 64a, 64b, 64c and 64d, see FIG. 13. During the movement of the rod, the permanent magnets 64a, 64b are provided to be opposite the stator sub-elements 35a and 34a, and the permanent magnets 64c, 64d are provided to face opposite the stator sub-elements 35b and 34b.

FIGS. 10 to 12 show a flow-generating device comprising two membranes. Each membrane is made of plastic, elastomer, or metal material so as to produce a hydraulic thruster, the electromagnetic machine operating in motor mode. With reference to FIG. 10, the rods 42, 44 and 46 are connected and controlled simultaneously so as to form a first sub-motor, called the upstream motor, and the rods 41, (43 and 45 not visible) are connected and controlled so as to form a second sub-motor, called the downstream motor. The ends of the rods 42, 44 and 46 are securely connected to a reinforcement bearing a membrane M1, called the upstream membrane. The ends of the rods 41, (43 and 45 not shown) are securely connected to a reinforcement bearing a membrane M2, called the downstream membrane. The membranes have a discoidal shape but may have other shapes. The sub-motors are electrically phase-shifted by 180° (degrees) so that the membranes M1 and M2 are actuated in phase opposition. In particular, the magnets are reversed, which allows the magnetic field to be truly circular and not be opposite the field of the next coil.

For the rest of the description, the operation and/or the movement of a rod of a sub-motor will be described.

With reference to FIGS. 12 and 13, the upstream membrane is located in a position proximal to the frame 2 of the machine. The position of the rod is such that the permanent magnet 64a is opposite the stator sub-elements 35a and 34a and the permanent magnet 64c is opposite the stator sub-elements 35b and 34b due to the fact that the magnetic fluxes induced in the air gaps, between on the one hand the stator sub-elements 35a and 34a and on the other hand the stator sub-elements 35b and 34b, are sufficient to produce a polarity, for example, a north pole, on one side and a reverse polarity, for example, a south pole, on the other side. Since each permanent magnet has a reverse polarity, the magnetic fluxes pass through the permanent magnets and keep them in position.

During a switching of current into the coils, the magnetic fluxes in the air gaps are inverted so that each pole of a permanent magnet is opposite an identical polarity, producing a repulsion force and a translation of the rod. At the same time, the magnetic fluxes come to pass through the adjacent permanent magnets, of reverse polarities, 64b and 64d so that an attraction force causes the rod to move in translation. As a result, the new position of the rod is such that the permanent magnet 64b is opposite the stator sub-elements 35a and 34a and the permanent magnet 64d is opposite the stator sub-elements 35b and 34b. The upstream membrane M1 is then located in a distal position.

According to a variant embodiment, a spacer is arranged between two adjacent permanent magnets of reverse polarity. With reference to FIG. 13, a spacer 164 is arranged between the permanent magnets 64a and 64b, and a spacer 264 is arranged between the permanent magnets 64c and 64d.

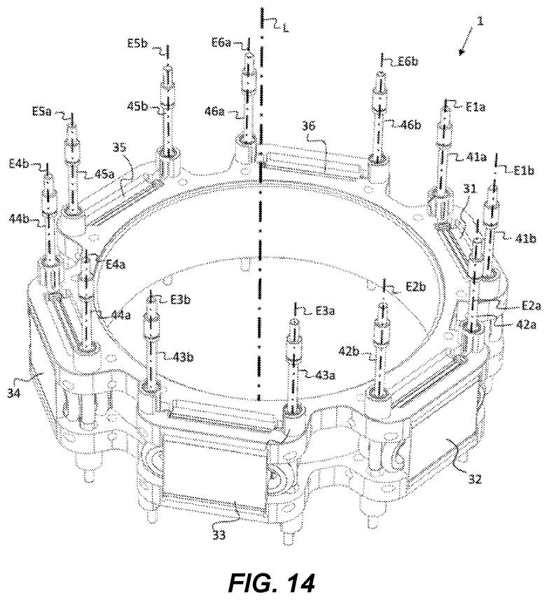

FIGS. 14 to 17 show a second type of actuator, in particular a second type of electromagnetic machine.

FIG. 14 shows an electromagnetic machine comprising six electromagnetic modules, an electromagnetic module will be described below. The electromagnetic machine comprises a stator and a movable portion comprising magnetic rods magnetically cooperating with the stator. The stator comprises six pairs of stator elements 31, 32, 33, 34, 35 and 36, the pair of stator elements 31 being associated with the pairs of rods 41a, 41b, the pair of stator elements 32 being associated with the pairs of rods 42a, 42b, the pair 33 of stator elements being associated with the pairs of rods 43a, 43b, the pair 34 of stator elements being associated with the pairs of rods 44a, 44b, the pair 35 of stator elements being associated with the pairs of rods 45a, 45b, the pair of stator elements 36 being associated with the pairs of rods 46a, 46b. The electromagnetic machine extends along a longitudinal axis L. The respective drive axes of the rods are parallel to the longitudinal axis L of the machine. Furthermore, the six modules are arranged along a circle whose longitudinal axis L is the center. The three electromagnetic modules are spaced equidistant.

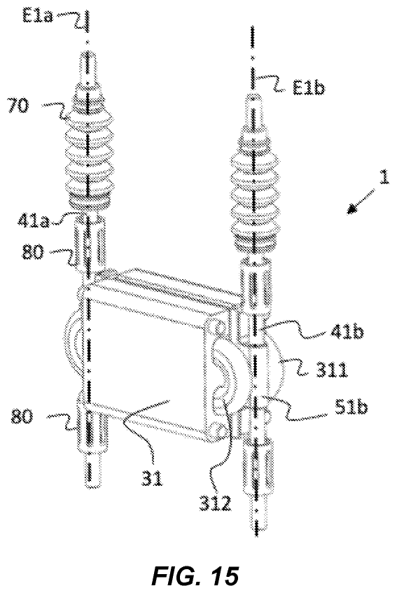

Referring to FIGS. 15, 16, and 17, a first embodiment of an electromagnetic machine 1 with cyclic linear movement is presented.

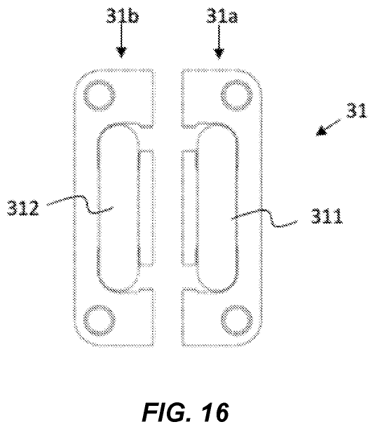

The module comprises a static part 31, called a stator, arranged to create an electromagnetic field. Referring to FIG. 16, the stator comprises two stator elements 31a and 31b, forming a pair of stator elements. Each stator element comprises a stack of sheet metal plates arranged so as to form an “E”-shaped pattern. Each stator element comprises three teeth and two notches. Each stator element 31a, 31b further comprises an electrical winding 311, 312 inserted into the notches of a stack of sheet metal plates so as to form a loop. The stator elements 31a, 31b are arranged opposite and spaced apart from each other by a distance making it possible to insert at least one magnetic element of the movable portion and an air gap distance. With reference to FIGS. 15 and 16, the stator elements have a general shape and a rectangular cross section and extending rectilinearly.

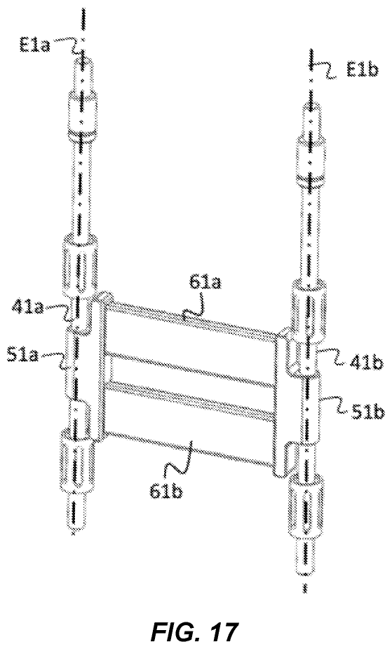

The module comprises a linearly movable portion carrying out an alternating rectilinear translational movement. With reference to FIGS. 15 and 17, the movable portion comprises two distinct rods 41a, 41b movable along respective drive axes E1a, E1b, the axes extending along an axis or a longitudinal direction. They are arranged on either side of the stator 31, in particular between the two winding portions, in the shape of a semicircle, extending outside the stacks of sheet metal plates. The rods 41a, 41b have a circular cross-section. With reference to FIG. 17, the movable portion comprises two permanent magnets 61a, 61b arranged between the two rods 41a, 41b. The permanent magnets have a rectangular shape. They are arranged to be inserted between the two stator elements 31a, 31b so as to move magnetically during the switching of the stator elements. The two magnets 61a, 61b are spaced apart longitudinally so that the two magnets can align with two consecutive teeth of a stator element.

The movable portion further comprises coupling means 51a, 51b between permanent magnets 61a, 61b and rods 41a, 41b. Each coupling means 51a, 51b comprises a rod part arranged to be fastened to a rod so as to be integral in translation. The rod part surrounds the outer envelope of a rod. Each coupling means 51a, 51b comprises a part of a magnetic element arranged to receive and fasten the two magnets and thus mechanically couple the magnets to a rod.

Optionally, the machine comprises two guide parts 80, preferably cylindrical, serving as a translational guide for each rod. The two guide parts attach to the longitudinal ends of the frame. These guide parts are advantageously made of non-magnetic materials in order to minimize magnetic field leakage. These two parts have the other function of serving as a connecting part for any effector or movable portion that needs to be set into motion.

Each type of electromagnetic machine makes it possible to provide a high-frequency linear movement, in particular up to 500 cycles per second, that is to say an operation at 500 Hz.

1. A device for generating a fluid flow extending in a longitudinal direction (L), comprising:
a frame;
at least one flange;
at least one membrane extending transversely and arranged opposite the at least one flange, the at least one membrane having an exterior face oriented toward the outside of the device,; and
at least one actuator configured to cause the at least one membrane to move in a reciprocating translational motion, and
wherein none of the walls are opposite the outer face of the at least one membrane.

2. The device of claim 1, wherein the at least one flange is arranged on a transverse face, the at least one membrane having a flange face opposite the at least one flange, the exterior face being opposite the flange face.

3. The device of claim 1, wherein the at least one flange comprises a single flange and the at least one membrane comprises a single membrane.

4. The device of claim 1, wherein the at least one flange comprises a single flange and the at least one membrane comprises a pair of membranes arranged one behind the other.

5. The device of claim 1, wherein the at least one flange comprises at least two flanges and the at least one membrane comprises at least two membranes, each of the at least two flanges being arranged at one distinct end of the frame or the actuator.

6. The device of claim 1, wherein the at least one flange has a tubular section extending coaxially to the longitudinal axis.

7. The device of claim 1, wherein the at least one membrane has a central opening.

8. The device of claim 1, wherein each of the at least one flange and the at least one membrane has an oval shape.

9. The device of claim 1, wherein the at least one actuator is arranged on or in the frame such that the device has a free central zone.

10. The device of claim 1, wherein the at least one electromagnetic actuator comprises:
a stator arranged to create a magnetic field, the stator comprising at least two stator elements, arranged around the longitudinal axis and extending in a circumferential or orthoradial direction relative to the longitudinal axis; and
a linearly movable portion comprising at least two distinct movable rods extending along respective drive axes and spaced along a circumference extending around the longitudinal axis, each of the at least two distinct movable rods comprising at least one magnetic element, each of the at least two distinct rods being arranged between two stator elements and being magnetically movable relative to the at least two stator elements.

11. The device of claim 1, wherein the at least one electromagnetic actuator comprises:
a stator arranged to create a magnetic field, the stator comprising at least two stator elements facing each other; and
a linearly movable portion, comprising:
at least two rods that are movable along respective drive axes, each of the at least two rods being arranged at one end of the two stator elements;
at least one magnetic element associated with the at least two rods, the at least one magnetic element being arranged between the at least two stator elements and being magnetically movable with respect to the at least two stator elements; and
coupling means between the at least one magnetic element and the at least two rods.

12. A hydraulic thruster for the propulsion of a nautical vehicle comprising a flow-generating device according to claim 1.

13. A hydrogenerator comprising a flow-generating device according to claim 1.

14. The device of claim 2, wherein the at least one flange comprises at least two flanges and the at least one membrane comprises at least two membranes, each of the at least two flanges being arranged at one distinct end of the frame or the actuator.

15. The device of claim 14, wherein the at least one flange has a tubular section extending coaxially to the longitudinal axis.

16. The device of claim 15, wherein the at least one membrane has a central opening.

17. The device of claim 16, wherein each of the at least one flange and the at least one membrane has an oval shape.

18. The device of claim 17, wherein the at least one actuator is arranged on or in the frame such that the device has a free central zone.

19. The device of claim 18, wherein the at least one electromagnetic actuator comprises:
a stator arranged to create a magnetic field, the stator comprising at least two stator elements arranged around the longitudinal axis and extending in a circumferential or orthoradial direction relative to the longitudinal axis; and
a linearly movable portion comprising at least two distinct movable rods extending along respective drive axes and spaced along a circumference extending around the longitudinal axis, each of the at least two distinct movable rods comprising at least one magnetic element, each of the at least two distinct rods being arranged between two stator elements and being magnetically movable relative to the at least two stator elements.

20. The device of claim 18, wherein the at least one electromagnetic actuator comprises:
a stator arranged to create a magnetic field, the stator comprising at least two stator elements facing each other; and
a linearly movable portion, comprising:
at least two rods that are movable along respective drive axes, each of the at least two rods being arranged at one end of the two stator elements;
at least one magnetic element associated with the at least two rods, the at least one magnetic element being arranged between the at least two stator elements and being magnetically movable with respect to the at least two stator elements; and
coupling means between the at least one magnetic element and the at least two rods.
